(19) United States
(12) Patent Application Publication
(10) Pub. No.: US 2016/0096293 A1
(43) Pub. Date: Apr. 7, 2016

(54) MAKING METHOD OF PLASTIC TOY WITH ADJUSTABLE HARDNESS AT LOCAL POSITIONS

(71) Applicant: Chun-Fa Liu, Changhua County (TW)

(72) Inventor: Chun-Fa Liu, Changhua County (TW)

(21) Appl. No.: 14/505,508

(22) Filed: Oct. 3, 2014

(51) Int. Cl. B29C 41/22; B29C 41/46; B29C 41/04

(52) U.S. Cl. CPC B29C 41/22; B29C 41/042; B29C 41/46; B29K 2105/0061

(57) ABSTRACT

A making method of a plastic toy with adjustable hardness at local positions is provided, including: a) preparing two kinds of plastic latex with desired hardness; b) making a first gel coat layer, adding one kind of the latex into a mold and heating the mold; c) making a second gel coat layer, adding the other kind of latex; d) gel forming of hard latex and soft latex, adding the first kind of latex and then heating again; e) cooling forming and uncovering demolding, carrying out water cooling and carrying out uncovering demolding after the cooling is completed; and 0 gel processing. The present invention solves the problem and meets the requirements of products about inconsistent hardness of various parts, makes the touch feel of the toys closer to that of the human skin, thus ensuring products having better quality, and bringing better realistic feel of the toy to people.

### BACKGORUND OF THE INVNETION

1. Field of The Invention

The present invention relates to a making method of a toy, in particular to a making method of a plastic toy with adjustable hardness at local positions.

2. Description of the Related Art

Most existing toys comprise only one layer with uniform texture, are monotonous in hand-feel and cannot meet the requirements of people on realistic feel of toys, particularly to bionic toys of human bodies, people further need multi-layered realistic hand-feel of different hardness textures. And with the emergence of multi-layered plastic with different hardness, the problem of monotonous hand-feel of the bionic toys is solved greatly. The traditional making method of a multi-layered plastic toy comprises the steps as follows: step 1, preparing plastic latex; step 2, selecting the plastic latex prepared in the step 1, injecting the plastic latex into a toy mold, heating and revolving until the plastic latex is attached to a mold wall and congealed, and then taking out the mold to obtain a single-layer plastic shell; and step 3, selecting a proper amount of the plastic latex prepared in the step 1, injecting the selected plastic latex into the single-layer plastic shell, heating and revolving until the plastic latex is gelled completely, and then taking out the mold, thereby obtaining a double-layer plastic shell; and other layers are made according to the characteristics of the toy by using the same method, thereby obtaining a toy product with different hardness layers.

In the abovementioned making process, the first kind of plastic latex has been congealed into the single-layer plastic shell on the mold wall in the step 1, and when injected into the single-layer plastic shell and heated and revolved, the second kind of latex cannot be adhered onto the single-layer plastic shell uniformly, so various parts of some made products are inconsistent in hardness degrees, and the realistic feel of people to the toys is influenced; and if the heating temperature is raised, the problem of inconsistent hardness degrees of various parts of the products can be solved, but the single-layer plastic shell is burned due to over-high temperature during actual operation, so the rejection rate of products is increased. In addition, in the prior art, no demolding operation is available after obtaining a double-layer plastic shell, however, the demolding is an essential process in actual making, and a nonstandard demolding method is likely to cause the damage of the mold and the plastic shell, therefore, the abovementioned method has yet to be improved.

### SUMMARY OF THE INVNETION

The present invention aims to overcome the defects of the prior art effectively and provide a making method, with good demolding effect and capabilities of solving the problem of inconsistent hardness degrees of various parts of products and increasing the product pass rate effectively, of a plastic toy with adjustable hardness at local positions.

The technical scheme of the present invention is achieved as follows: the improvement lies in that the making method comprises the following steps:

a) preparation of plastic latex, preparing two kinds of plastic latex with desired hardness as required, wherein the two kinds of plastic latex can be identical or different in hardness, moreover, the two kinds of plastic latex can also be constituted by mixing two kinds of plastic latex with different hardness, one of the two kinds of plastic latex is referred as softer latex and the other is referred as harder latex;

b) making of first layer of gel coat, selecting a proper amount of softer latex, adding the softer latex into a mold, putting the mold into a six-sided rotary furnace capable of revolving for 360 degrees, heating the mold at the temperature of 250-350 DEG C for 4-9 minutes so as to optimally adhere the softer latex onto a mold wall, then taking out the mold, and opening the mold cover, thereby obtaining the first layer of gel coat;

c) making of second layer of gel coat, adding the proper amount of the harder latex prepared in the step a into the mold, manually adhering the harder latex in the mold onto one mold wall, then closing the cover, and putting the mold into a four-sided revolving machine for rotating so as to adhere the harder latex onto the mold wall during cooling in the mold, thereby obtaining the second layer of gel coat;

d) making and gel forming of third layer of gel coat, taking out the mold, opening the mold cover, adding a proper amount of softer latex prepared in the step a, putting the mold into the six-sided rotary furnace again, and carrying out 360-degree revolving and heating at the temperature of 250-350 DEG C for 5-12 minutes so as to make the harder latex adhered onto the mold and the softer latex to be gel forming, thereby obtaining the third layer of gel coat and completing gel making;

e) cooling forming and uncovering demolding, taking out the mold, carrying out water cooling for 3-9 seconds for forming, carrying out uncovering demolding operation after cooling is completed, wherein the demolding is performed after residual oily smoke layer in the mold is completely blown by using an air gun after uncovering, and the gel is arranged in order after demolding so as to prevent deformation caused by extrusion;

f) gel processing, baking the gel for recovering, cooling for sizing, and trimming and finishing.

The present invention has the beneficial effects as follows: firstly, the plastic toy made according to the present invention has a structure with different hardness, is rich in hand-feel and can meet the requirements of people on realistic feel of the toy, so the toy is not merely a toy and but also has a touch feel closer to that of human skin, and particularly, the bionic toy of the human body can better meet the requirements of people on multi-layered realistic hand-feel of different hardness textures; secondly, after the first layer of plastic shell is completed, the harder latex is adhered onto the mold wall using a manual method by the invention, so the harder latex in the mold is adhered onto the mold wall during cooling in the mold, the present making method is good for distributing the harder latex on the mold wall more uniformly, solving the problem of inconsistent hardness degrees of various parts of some products favorably, ensuring the product quality to be better and brining better realistic feel of the toy to people, in addition, after the harder latex is added into the mold, heating is not needed, the harder latex can be adhered onto the mold wall by utilizing the waste heat from the first heating, therefore, the making process of the present invention has a better performance in saving energy; thirdly, when the uncovering demolding operation is carried out in the present invention, the demolding is carried out after the residual oily smoke layer in the mold is completely blown by using the air gun, the force desired by demolding is featured by skillfulness and rapidness without forcible pulling, otherwise, the mold or the plastic shell is likely to be damaged by forcible pulling, therefore, by means of the step design in such a way, the making process of the plastic toy is more perfect, the yield of products can be increased significantly, and the cost is saved; fourthly, in the invention, when the softer latex is added into the mold, the six-sided rotary furnace capable of revolving for 360 degrees is adopted for heating so as to better adhere the softer latex onto the mold wall and make all parts more uniform, furthermore, the heating temperature and the heating time are controlled strictly, thus, the product quality is obviously increased; and fifthly, water cooling forming is adopted for cooling in the present invention, and the cooling time is controlled, so the uncovering demolding is easier.

### BRIEF DESCRIPTION OF THE DRAWINGS

FIG. 1 is a flow schematic diagram of the present invention.

### DETAILED DESCRIPTION OF THE PREFERRED EMBODIMENTS

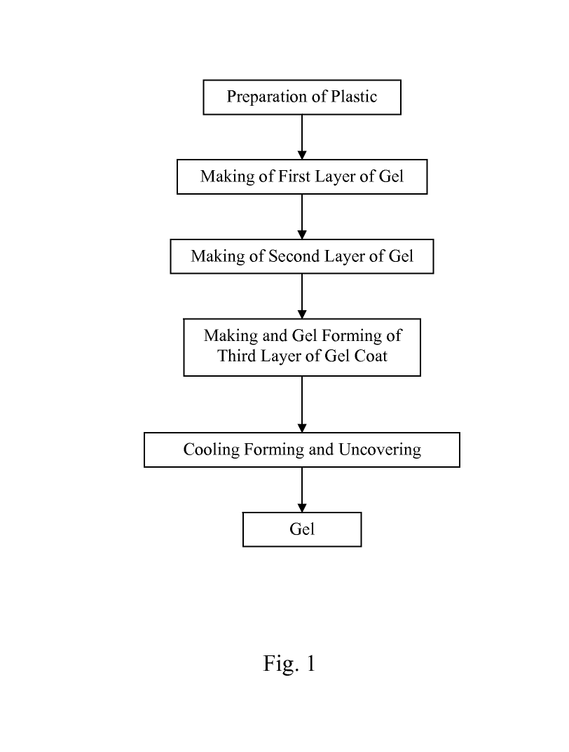

The present invention is described in detail hereinafter by combining FIG. 1 of the specification and specific embodiments.

### Embodiment 1

With reference to FIG. 1, the making method of the plastic toy with adjustable hardness at local positions comprises the following steps:

a) preparation of plastic latex, preparing two kinds of plastic latex with desired hardness as required, wherein the two kinds of plastic latex can be identical or different in hardness, moreover, the two kinds of plastic latex can also be constituted by mixing two kinds of plastic latex with different hardness, one of the two kinds of plastic latex is referred as softer latex and the other is referred as harder latex;

b) making of first layer of gel coat, selecting a proper amount of softer latex, adding the softer latex into a mold, putting the mold into a six-sided rotary furnace capable of revolving for 360 degrees, heating the mold at the temperature of 250-350 DEG C for 4-9 minutes so as to optimally adhere the softer latex onto a mold wall, then taking out the mold, and opening the mold cover, thereby obtaining the first layer of gel coat;

c) making of second layer of gel coat, adding the proper amount of the harder latex prepared in the step a into the mold, manually adhering the harder latex in the mold onto one mold wall, then closing the cover, and putting the mold into a four-sided revolving machine for rotating so as to adhere the harder latex onto the mold wall during cooling in the mold, thereby obtaining the second layer of gel coat;

d) making and gel forming of third layer of gel coat, taking out the mold, opening the mold cover, adding a proper amount of softer latex prepared in the step a, putting the mold into the six-sided rotary furnace again, and carrying out 360-degree revolving and heating at the temperature of 250-350 DEG C for 5-12 minutes so as to make the harder latex adhered onto the mold and the softer latex to be gel forming, thereby obtaining the third layer of gel coat and completing gel making;

e) cooling forming and uncovering demolding, taking out the mold, carrying out water cooling for 3-9 seconds for forming, carrying out uncovering demolding operation after cooling is completed, wherein the demolding is performed after residual oily smoke layer in the mold is completely blown by using an air gun after uncovering, and the gel is arranged in order after demolding so as to prevent deformation caused by extrusion;

f) gel processing, baking the gel for recovering, cooling for sizing, and trimming and finishing.

### Embodiment 2

With reference to FIG. 1, the making method of the plastic toy with adjustable hardness at local positions comprises the following steps:

a) preparation of plastic latex, preparing two kinds of plastic latex with desired hardness as required, wherein the two kinds of plastic latex can be identical or different in hardness, moreover, the two kinds of plastic latex can also be constituted by mixing two kinds of plastic latex with different hardness, one of the two kinds of plastic latex is referred as softer latex and the other is referred as harder latex;

b) making of first layer of gel coat, selecting a proper amount of softer latex, adding the softer latex into a mold, putting the mold into a six-sided rotary furnace capable of revolving for 360 degrees, heating the mold at the temperature of 270-330 DEG C for 5-8 minutes so as to optimally adhere the softer latex onto a mold wall, then taking out the mold, and opening the mold cover, thereby obtaining the first layer of gel coat;

c) making of second layer of gel coat, adding the proper amount of the harder latex prepared in the step a into the mold, manually adhering the harder latex in the mold onto one mold wall, then closing the cover, and putting the mold into a four-sided revolving machine for rotating so as to adhere the harder latex onto the mold wall during cooling in the mold, thereby obtaining the second layer of gel coat;

d) making and gel forming of third layer of gel coat, taking out the mold, opening the mold cover, adding a proper amount of softer latex prepared in the step a, putting the mold into the six-sided rotary furnace again, and carrying out 360-degree revolving and heating at the temperature of 270-330 DEG C for 6-11 minutes so as to make the harder latex adhered onto the mold and the softer latex to be gel forming, thereby obtaining the third layer of gel coat and completing gel making;

e) cooling forming and uncovering demolding, taking out the mold, carrying out water cooling for 4-8 seconds for forming, carrying out uncovering demolding operation after cooling is completed, wherein the demolding is performed after residual oily smoke layer in the mold is completely blown by using an air gun after uncovering, and the gel is arranged in order after demolding so as to prevent deformation caused by extrusion;

f) gel processing, baking the gel for recovering, cooling for sizing, and trimming and finishing.

### Embodiment 3

With reference to FIG. 1, the making method of the plastic toy with adjustable hardness at local positions comprises the following steps:

a) preparation of plastic latex, preparing two kinds of plastic latex with desired hardness as required, wherein the two kinds of plastic latex can be identical or different in hardness, moreover, the two kinds of plastic latex can also be constituted by mixing two kinds of plastic latex with different hardness, one of the two kinds of plastic latex is referred as softer latex and the other is referred as harder latex;

b) making of first layer of gel coat, selecting a proper amount of softer latex, adding the softer latex into a mold, putting the mold into a six-sided rotary furnace capable of revolving for 360 degrees, heating the mold at the temperature of 290-310 DEG C for 6-7 minutes so as to optimally adhere the softer latex onto a mold wall, then taking out the mold, and opening the mold cover, thereby obtaining the first layer of gel coat;

c) making of second layer of gel coat, adding the proper amount of the harder latex prepared in the step a into the mold, manually adhering the harder latex in the mold onto one mold wall, then closing the cover, and putting the mold into a four-sided revolving machine for rotating so as to adhere the harder latex onto the mold wall during cooling in the mold, thereby obtaining the second layer of gel coat;

d) making and gel forming of third layer of gel coat, taking out the mold, opening the mold cover, adding a proper amount of softer latex prepared in the step a, putting the mold into the six-sided rotary furnace again, and carrying out 360-degree revolving and heating at the temperature of 290-310 DEG C for 8-9 minutes so as to make the harder latex adhered onto the mold and the softer latex to be gel forming, thereby obtaining the third layer of gel coat and completing gel making;

e) cooling forming and uncovering demolding, taking out the mold, carrying out water cooling for 5-7 seconds for forming, carrying out uncovering demolding operation after cooling is completed, wherein the demolding is performed after residual oily smoke layer in the mold is completely blown by using an air gun after uncovering, and the gel is arranged in order after demolding so as to prevent deformation caused by extrusion;

f) gel processing, baking the gel for recovering, cooling for sizing, and trimming and finishing.

In the abovementioned operation steps, the key steps should be controlled strictly, for example, both the heating time and the heating temperature of the six-sided rotary furnace should be controlled strictly, otherwise, the first layer of gel coat is bound to be burned and rejected products are produced subsequently, in addition, the force for demolding is featured by skillfulness and rapidness without forcible pulling during uncovering and demolding, and after demolding, the gel is arranged in order without being extruded. According to the present invention, a manual method is adopted to adhere the harder latex onto the mold wall and then the mold is put in the four-sided revolving machine for heating, so the harder latex is distributed on the mold wall more uniformly, and the requirements of people on realistic hand-feel of multiple layers and different hardness textures of the plastic toys are met to a greater extent. When the softer latex is added into the mold, the six-sided rotary furnace capable of revolving for 360 degrees is used for heating, so the softer latex can better adhere onto the mold wall, all parts are more uniform, and thus, the product quality is increased obviously.

The abovementioned descriptions are only preferred embodiments of the present invention, and the above specific embodiments are not limitation to the present invention. Within the technical spirit of the present invention, various possible changes and modifications, and all revision, alternations or equivalent replacements made by those skilled in the art, are in the protection range of the present invention.

What is claimed is:

1. A making method of a plastic toy with adjustable hardness at local positions, characterized in that the making method comprises the steps as follows:
a) preparation of plastic latex, preparing two kinds of plastic latex with desired hardness as required, wherein the two kinds of plastic latex can be identical or different in hardness, moreover, the two kinds of plastic latex can also be constituted by mixing two kinds of plastic latex with different hardness, one of the two kinds of plastic latex is referred as softer latex and the other is referred as harder latex;
b) making of first layer of gel coat, selecting a proper amount of softer latex, adding the softer latex into a mold, putting the mold into a six-sided rotary furnace capable of revolving for 360 degrees, heating the mold at the temperature of 250-350 DEG C for 4-9 minutes so as to optimally adhere the softer latex onto a mold wall, then taking out the mold, and opening the mold cover, thereby obtaining the first layer of gel coat;
c) making of second layer of gel coat, adding the proper amount of the harder latex prepared in the step a into the mold, manually adhering the harder latex in the mold onto one mold wall, then closing the cover, and putting the mold into a four-sided revolving machine for rotating so as to adhere the harder latex onto the mold wall during cooling in the mold, thereby obtaining the second layer of gel coat;
d) making and gel forming of third layer of gel coat, taking out the mold, opening the mold cover, adding a proper amount of softer latex prepared in the step a, putting the mold into the six-sided rotary furnace again, and carrying out 360-degree revolving and heating at the temperature of 250-350 DEG C for 5-12 minutes so as to make the harder latex adhered onto the mold and the softer latex to be gel forming, thereby obtaining the third layer of gel coat and completing gel making;
e) cooling forming and uncovering demolding, taking out the mold, carrying out water cooling for 3-9 seconds for forming, carrying out uncovering demolding operation after cooling is completed, wherein the demolding is performed after residual oily smoke layer in the mold is completely blown by using an air gun after uncovering, and the gel is arranged in order after demolding so as to prevent deformation caused by extrusion;
f) gel processing, baking the gel for recovering, cooling for sizing, and trimming and finishing.

2. The making method of the plastic toy with adjustable hardness at local positions of claim 1, characterized in that:
The step b is making of a first layer of gel coat, selecting a proper amount of softer latex, adding the softer latex into a mold, putting the mold into a six-sided rotary furnace capable of revolving for 360 degrees, heating the mold at the temperature of 270-330 DEG C for 5-8 minutes so as to optimally adhere the softer latex onto a mold wall, then taking out the mold, and opening a mold cover, thereby obtaining the first layer of gel coat;
The step d is making and gel forming of a third layer of gel coat, taking out the mold, opening the mold cover, adding a proper amount of the softer latex prepared in the step a, putting the mold into the six-sided rotary furnace again, and carrying out 360-degree revolving and heating at a temperature of 270-330 DEG C for 6-11 minutes so as to make the harder latex adhered onto the mold and the softer latex to be gel forming, thereby obtaining the third layer of gel coat and completing gel making;
The step e is cooling forming and uncovering demolding, taking out the mold, carrying out water cooling for 4-8 seconds for forming, carrying out uncovering demolding operation after cooling is completed, performing the demolding after residual oily smoke layer in the mold is completely blown by using an air gun after uncovering, and arranging the gel in order after demolding so as to prevent deformation caused by extrusion.

3. The making method of the plastic toy with adjustable hardness at local positions of claim 1, characterized in that:
The step b is making of the first layer of gel coat, selecting a proper amount of the softer latex, adding the softer latex into a mold, putting the mold into a six-sided rotary furnace capable of revolving for 360 degrees, heating the mold at the temperature of 290-310 DEG C for 6-7 minutes so as to optimally adhere the softer latex onto the mold wall, then taking out the mold, and opening a mold cover, thereby obtaining the first layer of gel coat;
The step d is making and gel forming of the third layer of gel coat, taking out the mold, opening the mold cover, adding the proper amount of the softer latex prepared in the step a, putting the mold into the six-sided rotary furnace again, and carrying out 360-degree revolving and heating at the temperature of 290-310 DEG C for 8-9 minutes so as to make the harder latex adhered onto the mold and the softer latex to be gel forming, thereby obtaining the third layer of gel coat and completing gel making;
The step e is cooling forming and uncovering demolding, taking out the mold, carrying out water cooling for 5-7 seconds for forming, carrying out uncovering demolding operation after cooling is completed, performing the demolding after residual oily smoke layer in the mold is completely blown by using an air gun after uncovering, and arranging the gel in order after demolding so as to prevent deformation caused by extrusion.
